(19) United States
(12) Patent Application Publication
(10) Pub. No.: US 2016/0147429 A1
(43) Pub. Date: May 26, 2016

(54) DEVICE FOR RESIZING WINDOW, AND METHOD OF CONTROLLING THE DEVICE TO RESIZE WINDOW

(71) Applicant: SAMSUNG ELECTRONICS CO., LTD., Suwon-si (KR)

(72) Inventor: Kwang-sub BYUN, Suwon-si (KR)

(73) Assignee: SAMSUNG ELECTRONICS CO., LTD., Suwon-si (KR)

(21) Appl. No.: 14/941,738

(22) Filed: Nov. 16, 2015

(30) Foreign Application Priority Data
Nov. 20, 2014 (KR) 10-2014-0162606

(51) Int. Cl. G06F 3/0484; G06F 17/24

(52) U.S. Cl. CPC G06F 3/04847; G06F 17/24

(57) ABSTRACT

A device for resizing a window and a method of controlling the device are provided. The device includes a display that displays windows; and a processor that determines one of the windows as a target window, determines a partial area for acquiring a size of an object displayed in the target window, acquires a size of an object included in the determined partial area, resizes the target window based on the size of the object, and displays the resized target window.

### CROSS-REFERENCE TO RELATED PATENT APPLICATION

This application claims priority from Korean Patent Application No. 10-2014-0162606, filed on Nov. 20, 2014, in the Korean Intellectual Property Office, the disclosure of which is incorporated by reference herein in its entirety.

### BACKGROUND

1. Field

The present disclosure relates to devices for resizing a window and methods of controlling the devices, and more particularly, to a device and method of resizing a window based on the size of an object displayed on the window and displaying a resized window.

2. Description of the Related Art

As various terminals such as personal computers (PCs), laptop computers, smart TVs, and cellular phones provide multiple and various functions, there is a trend to providing a multi-window function. The multi-window function means a function of splitting a screen into a plurality of areas and independently displaying a plurality of pieces of content or application programs simultaneously.

There is a recent research into a method in which a terminal providing the multi-window function provides a user with a more convenient viewing environment.

### SUMMARY

It is an aspect to provide devices and methods for resizing a window based on the size of an object displayed on the window and displaying a resized window.

Additional aspects will be set forth in part in the description which follows and, in part, will be apparent from the description, or may be learned by practice of the presented exemplary embodiments.

According to an aspect of an exemplary embodiment, a device includes a display configured to display a plurality of windows; and a processor configured to determine one of the plurality of windows as a target window, determine at least a partial area for acquiring a size of an object displayed in the target window, acquire a size of an object included in the determined at least partial area, resize the target window based on the size of the object, and display the resized target window.

When the size of the object is less than or equal to a reference size, the processor may enlarge the size of the target window and display the size-enlarged target window, and, when the size of the object is greater than the reference size, the processor may reduce the size of the target window and display the size-reduced target window.

The processor may determine the target window based on a user input of selecting one window from among the plurality of windows.

The processor may determine the at least a partial area based on an area including text in the target window.

The processor may change a position or a size of the at least a partial area, based on a user input.

When the position or size of the at least a partial area has been changed, the processor may reacquire the size of the object.

The processor may determine a center area corresponding to a ratio of the target window, as the at least a partial area for acquiring the size of the object.

The processor may control an indicator indicating the at least a partial area for acquiring the size of the object, to be displayed in the target window.

The processor may acquire the size of text included in the determined at least a partial area, or recognize text from an image included in the determined at least a partial area, and then acquire a size of the recognized text.

The processor may acquire the size of the object periodically based on a time interval.

The processor may automatically determine whether to resize the target window at each acquisition of the size.

The processor may receive a user input regarding whether to resize the target window the acquisition of the size.

The processor may determine a ratio for resizing the target window, based on preset user information, wherein the preset user information comprises at least one of size information of a preferred window, age information, and eyesight information.

The device may further comprise a sensor module configured to acquire a distance by which a user is separated from the device, wherein the processor determines a ratio for resizing the target window, based on the distance.

As the processor resizes the target window, the processor may resize windows other than the target window from among the plurality of windows displayed on the display.

According to another aspect of an exemplary embodiment, a method comprises determining, as a target window, one of a plurality of windows displayed on a display; determining at least a partial area for acquiring a size of an object displayed in the target window; acquiring a size of an object included in the determined at least a partial area; and resizing the target window based on the size of the object and displaying the resized target window.

The resizing of the target window based on the size of the object and displaying of the resized target window may comprise, when the size of the object is less than or equal to a reference size, enlarging the size of the target window and displaying the size-enlarged target window, and, when the size of the object is greater than the reference size, reducing the size of the target window and displaying the size-reduced target window.

The target window may be determined by selecting one from among the plurality of windows based on a user input.

The at least a partial area may be determined based on an area including text in the target window.

The determining of the at least partial area may comprise changing a position or a size of the at least a partial area based on a user input.

The method may further comprise, when the position or size of the at least a partial area has been changed, reacquiring the size of the object.

The determining of the at least a partial area may comprise determining a center area corresponding to a ratio of the target window, as the at least a partial area.

The method may further comprise displaying an indicator for indicating the at least a partial area in the target window.

The acquiring of the size of the object may comprise acquiring the size of text included in the determined at least a partial area, or recognizing text from an image included in the determined at least a partial area, and then acquiring a size of the recognized text.

The size of the object may be acquired periodically based on a time interval.

The method may automatically determine whether to resize the target window at each acquisition of the size of the object.

The method may further comprise receiving a user input regarding whether to resize the target window at the acquisition of the size of the object.

The resizing of the target window based on the size of the object and displaying of the resized target window may comprise determining a ratio for resizing the target window based on preset user information, and the preset user information may comprise at least one of age information, eyesight information, and size information of a preferred window.

The resizing of the target window based on the size of the object and displaying of the resized target window may comprise acquiring a distance by which a user is separated from the device, and determining a ratio for resizing the target window, based on the distance.

The method may further comprise, as the target window is resized, resizing windows other than the target window from among the plurality of windows displayed on the display.

According to another aspect of an exemplary embodiment, a device comprises a display configured to display a plurality of windows; and a processor configured to automatically resize a window of the plurality of windows in response to a change in the size of an object included in the window.

The object may be text, and the change may be a change in the size of the text.

The object may be an image, and the change may be a change in the size of the image.

The processor may determine a size of the object, and when the size of the object is less than or equal to a reference size, the processor may enlarge the size of the window that includes the object and display the size-enlarged window, and, when the size of the object is greater than the reference size, the processor may reduce the size of the window that includes the object and display the size-reduced target window

As the processor resizes the window, the processor may also resize one or more of remaining windows among the plurality of windows.

As the processor increases the size of the window, the processor may decrease the size of one or more of remaining windows among the plurality of windows.

As the processor decreases the size of the window, the processor may increase the size of one or more of remaining windows among the plurality of windows.

### BRIEF DESCRIPTION OF THE DRAWINGS

These and/or other aspects will become apparent and more readily appreciated from the following description of the exemplary embodiments, taken in conjunction with the accompanying drawings in which:

FIGS. 1A and 1B illustrate resizing a window in a device, according to an exemplary embodiment;

FIG. 2 is a flowchart for explaining resizing a window in a device, according to an exemplary embodiment;

FIG. 3 is a view for explaining an example of determining a target window, according to an exemplary embodiment;

FIG. 4 is a view for explaining an example of determining an area for acquiring the size of an object, according to an exemplary embodiment;

FIGS. 5A and 5B are views for explaining another example of determining an area for acquiring the size of an object, according to an exemplary embodiment;

FIG. 6 is a flowchart for explaining an example of resizing a target window, according to an exemplary embodiment;

FIGS. 7A and 7B and 8A and 8B are views for explaining an example of resizing a target window, according to an exemplary embodiment;

FIGS. 9A and 9B are flowcharts for explaining an example of periodically determining whether to resize a target window, according to exemplary embodiments;

FIG. 10 is a view for explaining an example of periodically determining whether to resize a target window, according to an exemplary embodiment;

FIGS. 11A and 11B are views for explaining an example of determining a resizing ratio of a target window, according to an exemplary embodiment;

FIGS. 12A through 12C are views for explaining an example of rearranging windows other than a target image according to resizing of the target window, according to an exemplary embodiment; and

FIGS. 13 and 14 are block diagrams of a device according to an exemplary embodiment.

### DETAILED DESCRIPTION

Exemplary embodiments are described in detail herein with reference to the accompanying drawings so that this disclosure may be easily performed by one of ordinary skill in the art to which the exemplary embodiments pertain. The inventive concept may, however, be embodied in many different forms and should not be construed as being limited to the exemplary embodiments set forth herein. In the drawings, parts irrelevant to the description are omitted for simplicity of explanation, and like numbers refer to like elements throughout.

The above-described objectives, features, and merits will be more apparent via the following detailed description in connection with the accompanying drawings. As the inventive concept allows for various changes and numerous embodiments, particular exemplary embodiments will be illustrated in the drawings and described in detail in the written description. Like reference numerals in the drawings basically denote like elements. In the description, certain detailed explanations of related-art functions or structures are omitted when it is deemed that the certain detailed explanations may unnecessarily obscure the essence of the inventive concept. While such terms as “first,” “second,” etc., may be used to describe various components, such components must not be limited to the above terms. The above terms are used only to distinguish one component from another.

Devices associated with the present inventive concept will now be described in more detail with reference to the accompanying drawings.

Examples of a device described in the specification may include, but are not limited to, fixed terminals, such as a digital TV and a desktop computer, and mobile terminals, such as a smartphone, a tablet personal computer (PC), a laptop computer, a digital broadcasting terminal, a personal digital assistant (PDA), a portable multimedia player (PMP), and a navigation device.

Throughout the specification, when an element is referred to as being “connected” or “coupled” to another element, it can be directly connected or coupled to the other element, or can be electrically connected or coupled to the other element with intervening elements interposed therebetween. In addition, the terms “comprises” and/or “comprising” or “includes” and/or “including” when used in this specification, specify the presence of stated elements, but do not preclude the presence or addition of one or more other elements. As used herein, the term “and/or” includes any and all combinations of one or more of the associated listed items. Expressions such as “at least one of,” when preceding a list of elements, modify the entire list of elements and do not modify the individual elements of the list.

Hereinafter, terms used in the specification are briefly described.

A display 121 of a device 100 according to an exemplary embodiment may provide a multi-window function.

The multi-window function means a function of splitting a screen into a plurality of areas and independently displaying a plurality of pieces of content or application programs simultaneously in the plurality of areas. The plurality of pieces of content or application programs may be provided in various windows that are displayed in theareas of the screen. Thus, for example, a first split screen area may display a first window showing a first content or application program, and a second split screen area may display a second window showing a second content or application program.

Throughout the specification, term ‘target window’ means a window that is determined to be resized from among a plurality of windows that are provided in a multi-window environment. The target window does not indicate a fixed specific window from among the plurality of windows but indicates any window that is to be controlled to be resized by the device 100.

The device 100 may determine one of the plurality of windows as a target window according to a criterion. The criterion may be predetermined. Alternatively, the target window may be determined according to a user input.

Throughout the specification, term ‘object’ means an object that is displayed on the screen of the display 121. For example, when a screen image for executing a certain application is displayed on the display 121, ‘object’ may mean, for example, text, a symbol, or an image included in the screen image for executing a certain application. As another example, when a screen image of content is displayed on the display 121, ‘object’ may mean, for example, a portion of the screen image or the entire screen image.

An exemplary embodiment will now be described more fully with reference to the accompanying drawings, in which exemplary embodiments of the invention are shown.

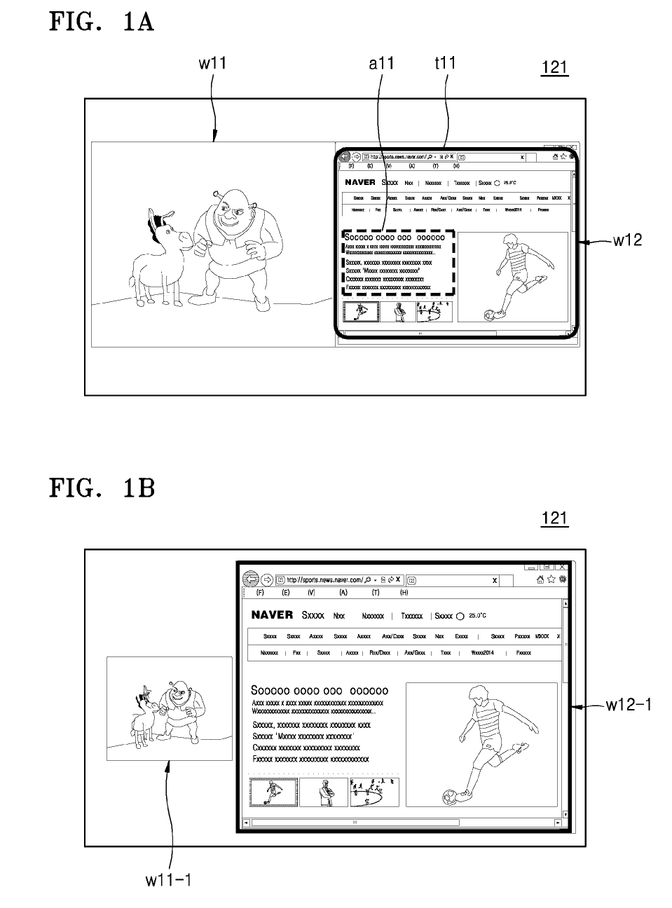

FIGS. 1A and 1B illustrate multi-windows in a device, according to an exemplary embodiment.

A device according to an exemplary embodiment may provide a multi-window function including a plurality of windows. In order to enhance readability of content displayed in a window that a user is interested in from among the plurality of windows, the device may automatically enlarge or shrink the size of the window. For example, if the size of text displayed on the window that a user is interested in is too small for the user to read the text, the device increases the ability of the user to read, by enlarging the size of the window and displaying an enlarged window.

In other words, the user may more conveniently watch the window of interest without needing to directly set or change the size of each of the plurality of windows while watching the plurality of windows.

FIGS. 1A and 1B briefly illustrate resizing a window of a multi-window according to an exemplary embodiment. FIG. 1A illustrates an example in which a second window w12 from among a first window w11 and the second window w12 is determined as a target window, and FIG. 1B illustrates an enlarged target window w12-1.

In other words by way of example, when a device 100 according to an exemplary embodiment acquires the size of text from a partial area of the second window w12 (see FIG. 1A) determined as a target window and determines that the size of the text is too small for a user to read, the device 100 may enlarge the target window as illustrated in FIG. 1B.

The device 100 may display a frame-shaped indicator t11 that outlines a window and indicates that the outlined window is a target window. The frame-shaped indicator t11 is only an example, and thus may be displayed in various other shapes.

As shown in FIG. 1A, an indicator a11 may indicate a target area (i.e., the partial area) for acquiring the size of an object (for example, text). While the indicator a11 is shown as a dashed box in FIG. 1A, this is only an example and other methods may be used to indicate the target area.

Although two windows are displayed on the display 121 in FIGS. 1A and 1B, more than two windows, for example, three or four windows, may be displayed on the display 121.

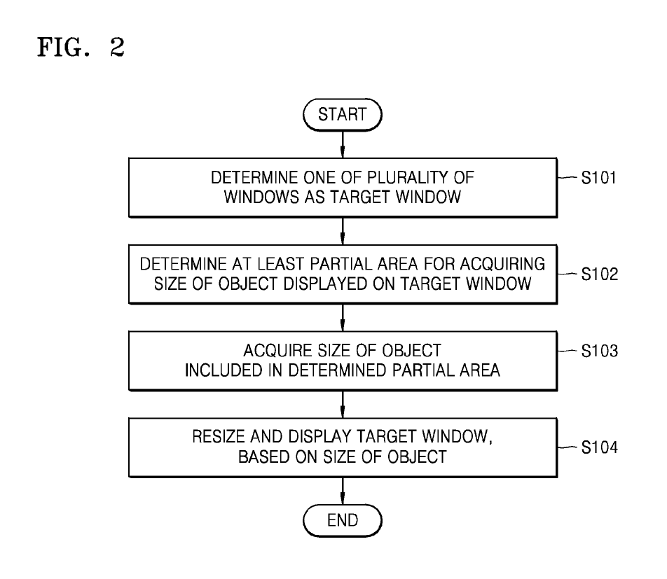

FIG. 2 is a flowchart for explaining an exemplary embodiment.

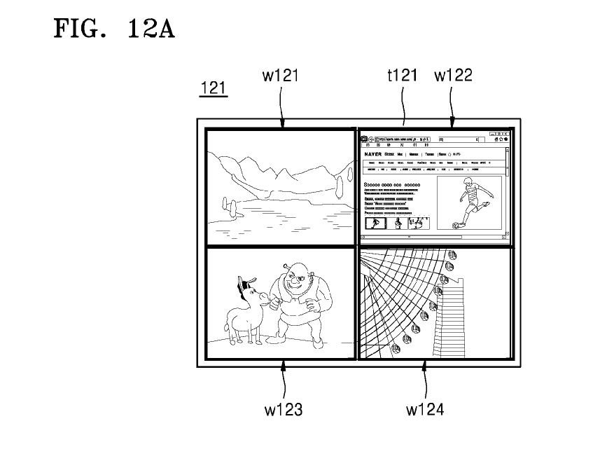

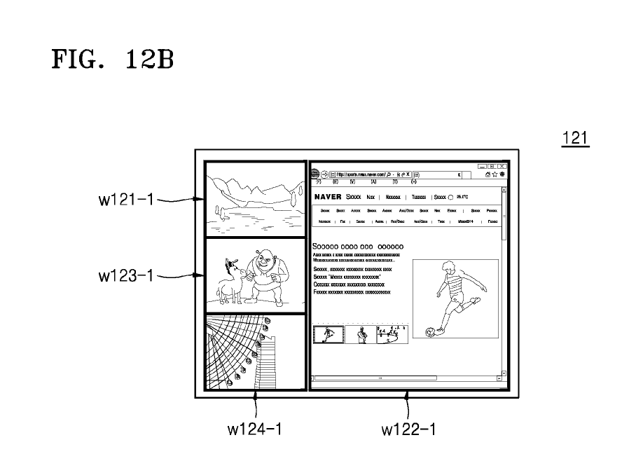

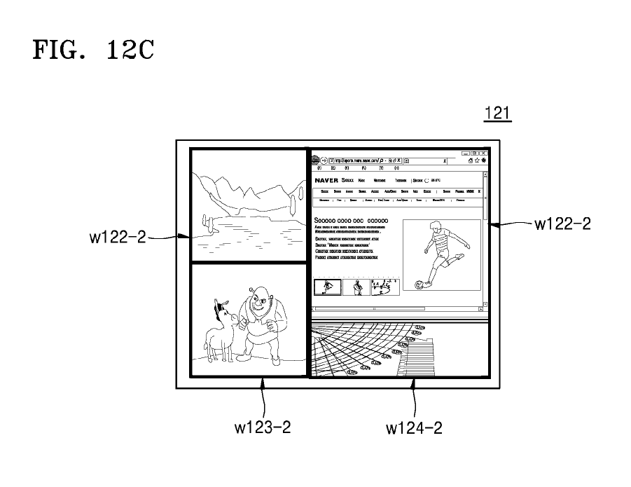

In operation S101, a processor 130 (see FIG. 12) of the device 100 may determine one of a plurality of windows as a target window.

The device 100 may automatically determine the target window according to a criterion. The criterion may be predetermined. For example, the criterion may be a window that is disposed on a specific location (for example, a left upper portion of the display 121) or a window that has been the most recently set as a target window, but is not limited thereto.

Alternatively, the device 100 may determine the target window according to a user input signal of selecting a specific window. For example, when the user selects one from a plurality of windows displayed on a TV monitor by using a remote controller, the selected window may be determined as the target window.

In operation S102, the processor 130 of the device 100 may determine at least a partial area for acquiring the size of an object displayed on the target window.

For example, the processor 130 of the device 100 may determine an area where text is displayed at a threshold percentage or more of the entire size of the target window as the area for acquiring the size of the object, in order to acquire the size of the text displayed in the target window.

According to an exemplary embodiment, the processor 130 of the device 100 may determine a center area corresponding to a threshold percentage of the entire size of the target window within the target window, as the area for acquiring the size of the object. The threshold percentage may be predetermined. For example, the center area corresponding to the threshold percentage may be an area that extends from the center of the target window by a quarter of the entire size of the target window.

According to an exemplary embodiment, the processor 130 of the device 100 may determine an area selected by a user input, as the partial area for acquiring the size of the object.

In operation S103, the processor 130 of the device 100 may acquire the size of an object included in the partial area determined in operation S102.

For example, the processor 130 of the device 100 may acquire the size of text included in the determined partial area. The processor 130 of the device 100 may extract a font size from the text, or recognize text from an image included in the determined partial area and then extract a font size of the recognized text.

The processor 130 of the device 100 may extract the size of the image included in the determined partial area.

In operation S104, the processor 130 of the device 100 may resize and display the target window, based on the size of the object acquired in operation S103.

When the size of the object is less than or equal to a reference size, the device 100 may enlarge and display the target window. The reference size may be preset. When the size of the object is greater than the reference size, the device 100 may reduce the size of the target window and display the size-reduced target window.

For example, when the size of text displayed on the target window is less than or equal to a minimum text size, the device 100 enlarges the size of the target window and thus a user may more conveniently check the text without directly adjusting the size of the target window. The minimum text size may be preset.

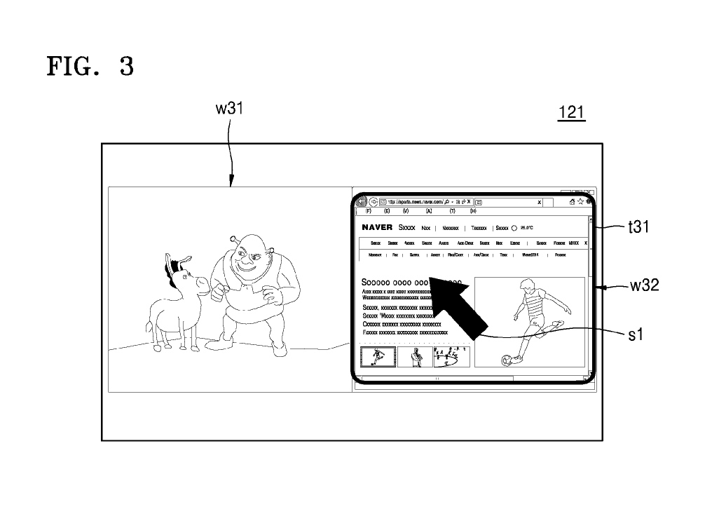

FIG. 3 is a view for explaining an example of determining a target window, according to an exemplary embodiment.

According to an exemplary embodiment, the processor 130 of the device 100 may determine the target window, based on a user input of selecting one from among a plurality of windows.

For example, in response to a user input signal of selecting one from among a first window w31 and a second window w32 of FIG. 3, the device 100 may determine the selected window as the target window.

Referring to FIG. 3, in response to a user signal of moving a direction key or a pointer of a remote controller according to an operation of the remote controller, the device 100 (for example, a TV) may display and move a pointer s1 for selecting a target window, on the first window w31 and/or the second window w32. For example, as shown in FIG. 3, the pointer s1 is moved over the second window w32 to select the second window w32 as the target window.

A frame-shaped indicator t31 indicating that an indicated window is the target window may be displayed on the window pointed by the pointer s1. For example, as shown in FIG. 3, the pointer s1 is moved over the second window w32 and thus the second window w32 is indicated as the target window using a bold border t31.

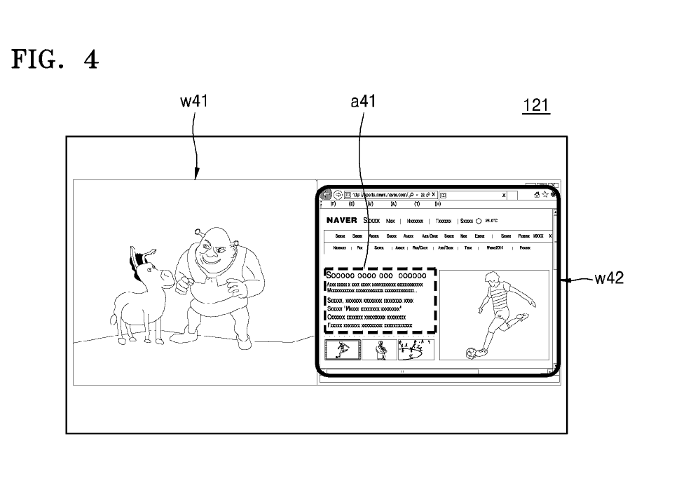

FIG. 4 is a view for explaining an example of determining an area for acquiring the size of an object, according to an exemplary embodiment.

According to an exemplary embodiment, the processor 130 of the device 100 may determine the area for acquiring the size of an object, based on an area including text on a target window.

For example, in order to acquire the size of text displayed on the target window, the processor 130 of the device 100 may determine the area for acquiring the size of the object, based on an area on which a threshold percentage or more of text is displayed. The threshold percentage may be predetermined. Determining the area means that the area for acquiring the size of the object is automatically determined based on an area including a high percentage of text.

Referring to FIG. 4, an indicator a41 indicating that an indicated area is the area for acquiring the size of the object may be displayed on a target window w42.

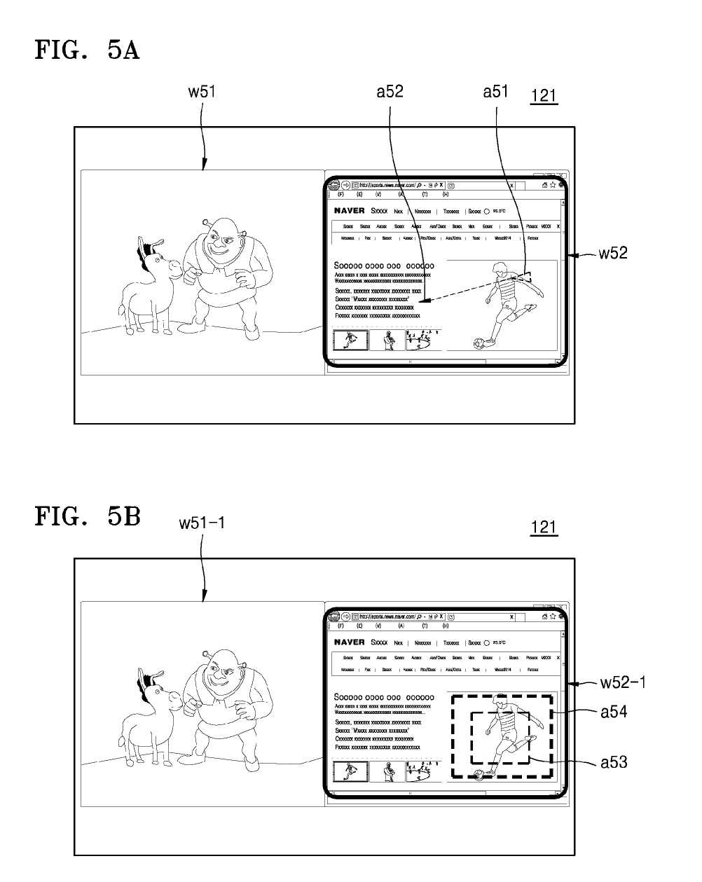

FIGS. 5A and 5B are views for explaining another example of determining an area for acquiring the size of an object, according to an exemplary embodiment.

According to an exemplary embodiment, the processor 130 of the device 100 may change the position of the area for acquiring the size of an object, or resize the area, based on a user input. FIG. 5A illustrates an example of changing the position of the area, and FIG. 5B illustrates an example of resizing the area.

Referring to FIG. 5A, when the processor 130 of the device 100 receives an input signal of moving an indicator a51 displayed on a target window w52 (for example, an input signal according to an operation of a remote controller of a user or a user touch input made on a touch screen), the processor 130 moves the indicator from an area on which a first indicator a51 is displayed to an area on which a second indicator a52 is displayed. For example, the indicator may be moved such that the area for acquiring the size of the object may be determined based on an area including text. That is, in FIG. 5A, an example of a small arrow as the indicator is shown, and the small arrow is moved from position shown by a51 to position shown by a52, such that the area is changed from the area displaying the soccer player to the area displaying the text.

Referring to FIG. 5B, when the processor 130 of the device 100 receives an input signal of enlarging an indicator (i.e., a dashed box) displayed on a target window w52-1 (for example, an input signal according to an operation of a remote controller of a user or a user touch input made on a touch screen), the processor 130 may enlarge the indicator from a size indicated by a third indicator a53 to a size indicated by a fourth indicator a54. For example, the size of the indicator may be enlarged by the size of an image displayed on the target window w52-1 such that the area for acquiring the size of the object may be determined based on an area including an image.

When the area for acquiring the size of the object is relocated or resized, the processor 130 of the device 100 may re-acquire the size of the object. In other words, the area for acquiring the size of the object may be changed, and, when the area is relocated or resized, the processor 130 of the device 100 may re-acquire the size of an object included in the changed area.

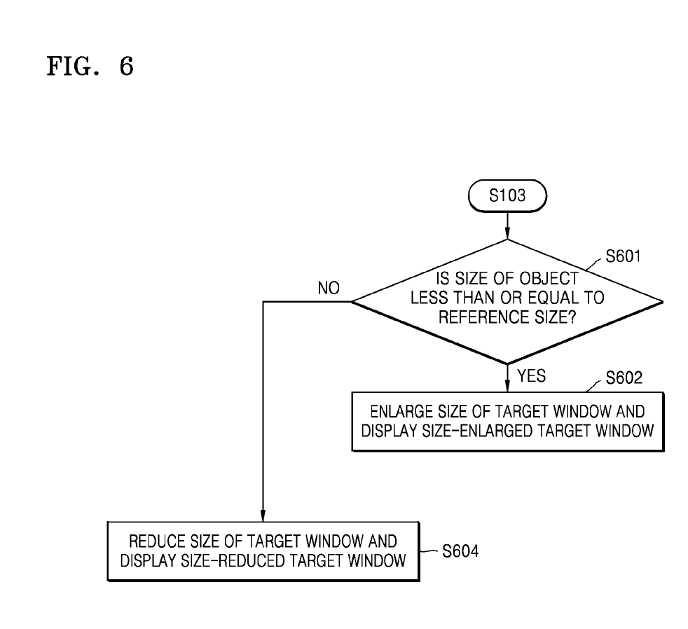

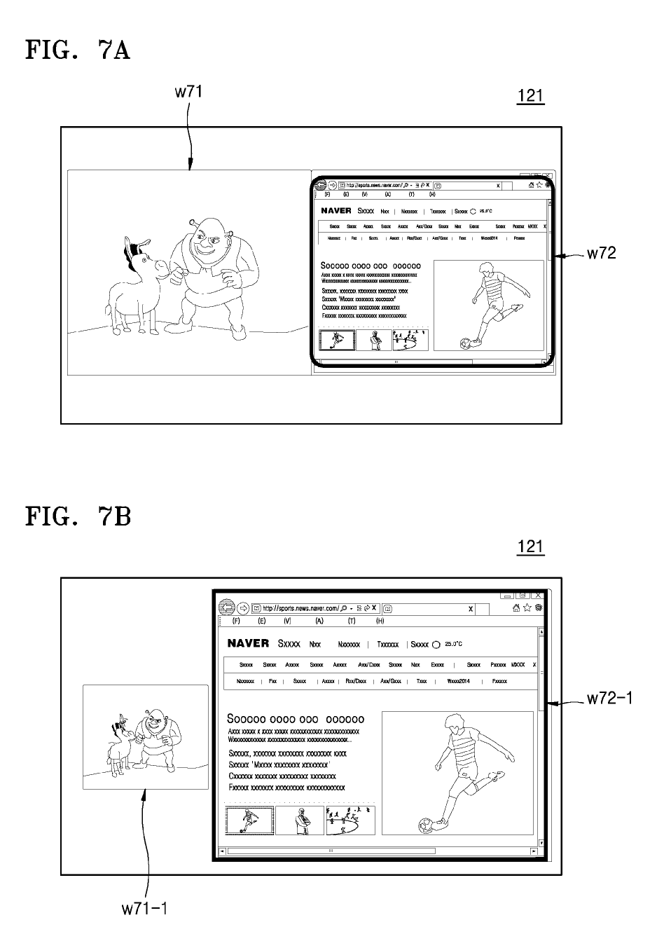

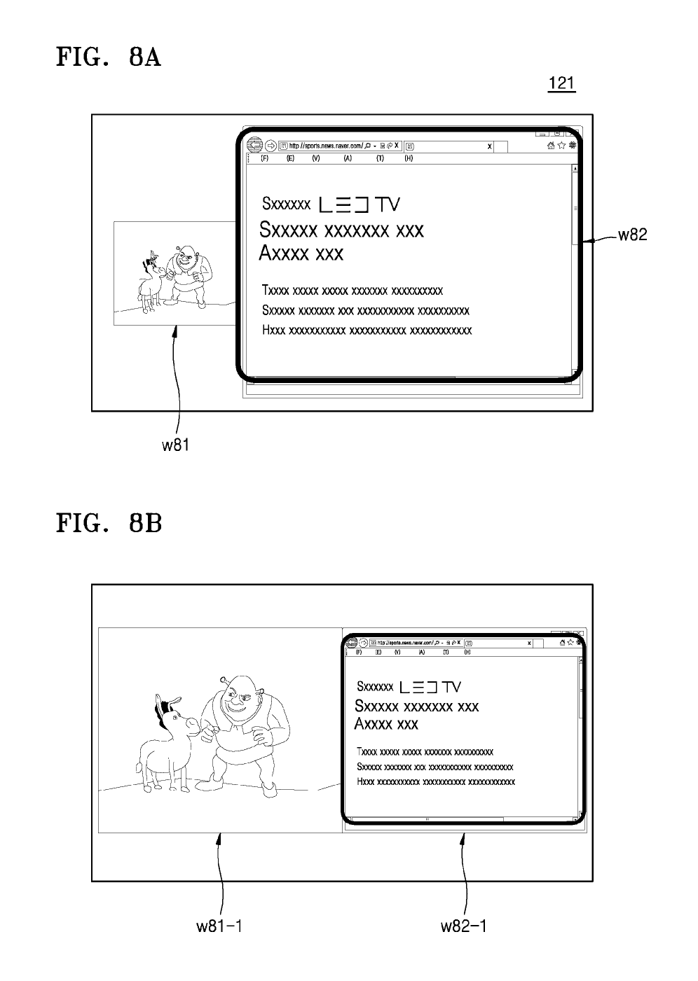

FIG. 6 is a flowchart for explaining an example of resizing a target window, according to an exemplary embodiment. FIGS. 7A and 7B and 8A and 8B are views for explaining an example of resizing a target window, according to an exemplary embodiment.

In operation S103 of FIG. 2, the processor 130 of the device 100 may acquire the size of an object (e.g., text) included in an area for acquiring the size of an object.

In operation S601 of FIG. 6, the processor 130 of the device 100 may determine whether the size of the object acquired in operation S103 is less than or equal to a reference size. The reference size may be predetermined, or may be determined experimentally based on, for example, a type of content.

In operation S602 of FIG. 6, when the processor 130 of the device 100 determines in operation S601 that the size of the object is less than or equal to the reference size (operation S601, YES), the processor 130 of the device 100 may enlarge the size of the target window and display a size-enlarged target window. For example, when the size of text is less than or equal to a minimum font size or the size of an image is less than or equal to a minimum size, the device 100 may increase the ability of a user to read, by enlarging the size of the target window. The minimum font size and/or the minimum size may be preset.

Referring to FIGS. 7A and 7B, the device 100 may display a target window w72 of FIG. 7A as an enlarged window w72-1 of FIG. 7B.

As the device 100 enlarges the size of the target window w72, the device 100 may reduce the size of a window w71 of FIG. 7A and thus display a window w71-1 of FIG. 7B.

Returning to FIG. 6, on the other hand, when the size of the object is not less than or equal to the reference size (operation S601, NO), the processor 130 of the device 100 may reduce the size of the target window and display a size-reduced target window.

For example, when the ability of a user to read may rather degrade due to an excessively large size of text, the size of a target window may be reduced.

Referring to FIGS. 8A and 8B, the device 100 may reduce the size of a window w82 of FIG. 8A to thus display a target window w82-1 of FIG. 8B.

As the device 100 reduces the size of the target window w82, the device 100 may enlarge the size of a window w81 of FIG. 8A and thus display a window w81-1 of FIG. 8B.

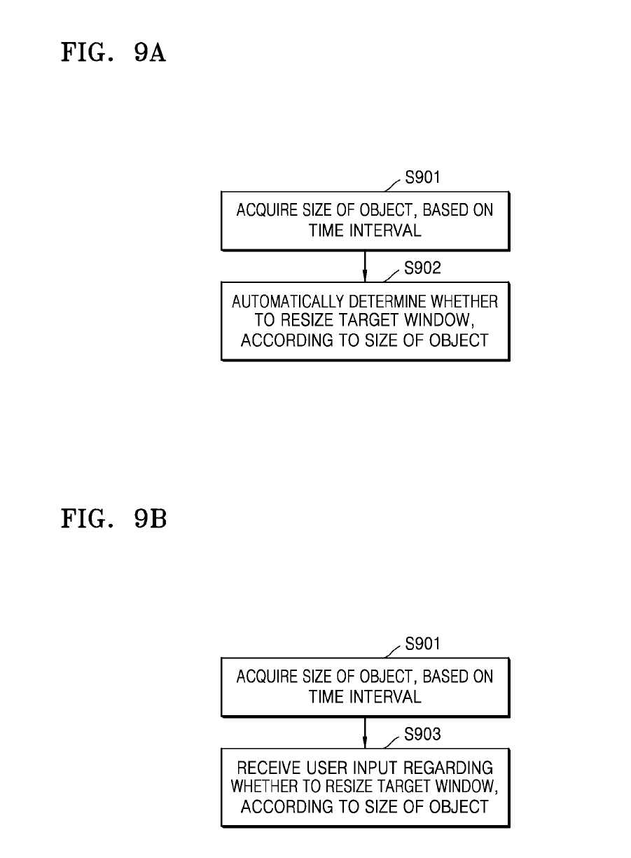

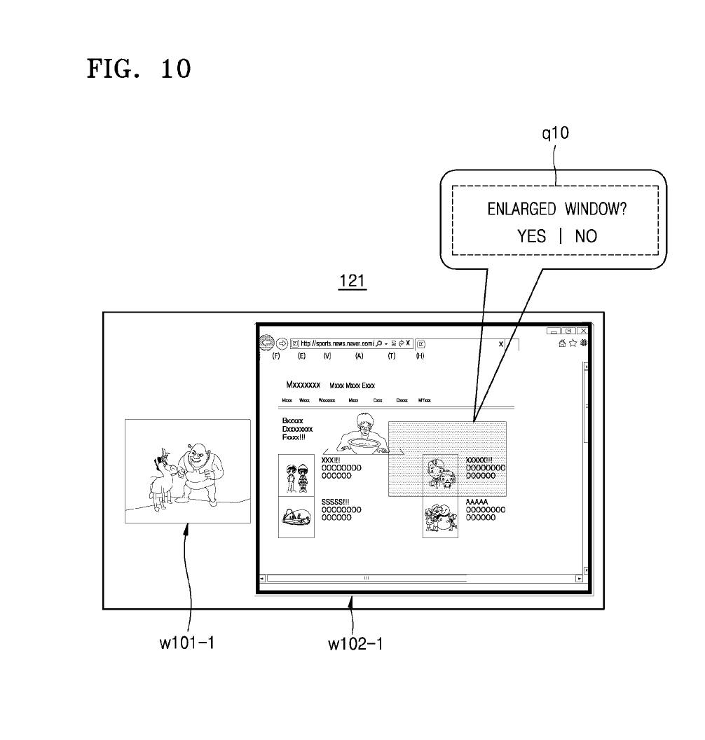

FIGS. 9A and 9B are flowcharts for explaining an example of periodically determining whether to resize a target window, according to exemplary embodiments. FIG. 10 is a view for explaining an example of periodically determining whether to resize a target window, according to an exemplary embodiment.

According to an exemplary embodiment, the processor 130 of the device 100 may acquire the size of an object based on a time interval and resize a window according to a change in the size of the object. That is, at a certain time interval, the processor 130 of the device 100 may acquire the size of an object and resize the window according to a change in the size of the object. For example, when text displayed on an image screen for executing an application that is being executed on a target window is resized, the size of the target window may be adjusted such that a user may read the text without any inconvenience.

In operation 5901 of FIG. 9A, the processor 130 of the device 100 may acquire the size of the object, based on the time interval. For example, the processor 130 of the device 100 may acquire the size of the object at the time interval (e.g., every x seconds).

In operation 5902 of FIG. 9A, the processor 130 of the device 100 may automatically determine whether to resize the target window, according to the size of the object.

For example, when the device 100 determines that the size of the object is less than or equal to a reference size, the device 100 may automatically enlarge the size of the target window. On the other hand, when the device 100 determines that the size of the object is greater than the reference size, the device 100 may automatically reduce the size of the target window. The reference size may be predetermined.

In other words, even after enlarging or reducing the size of the target window, the device 100 periodically acquires the size of, for example, text based on the time interval and when the text has been resized, resizes the target window according to the size of the resized text, thereby automatically providing enhanced readability to a user.

According to another exemplary embodiment, the processor 130 of the device 100 may enable a user to determine whether to resize the target window.

In operation 5901 of FIG. 9B, the processor 130 of the device 100 may acquire the size of the object, based on the time interval. For example, the processor 130 of the device 100 may acquire the size of the object at the time interval (e.g., every x seconds).

In operation 5903 of FIG. 9B, the processor 130 of the device 100 may receive a user input regarding whether to resize the target window, according to the size of the object.

For example, when the device 100 acquires the size of an object based on the predetermined time interval and determines that the size of the object is smaller than the predetermined reference, the device 100 may receive a user input regarding whether to enlarge the size of the target window.

Referring to FIG. 10, when the device 100 determines that the size of text acquired from a target window w102-1 is less than the reference size, the device 100 may display on the display 121 a pop-up window q10 for receiving a user input regarding whether to enlarge the size of the target window w102-1.

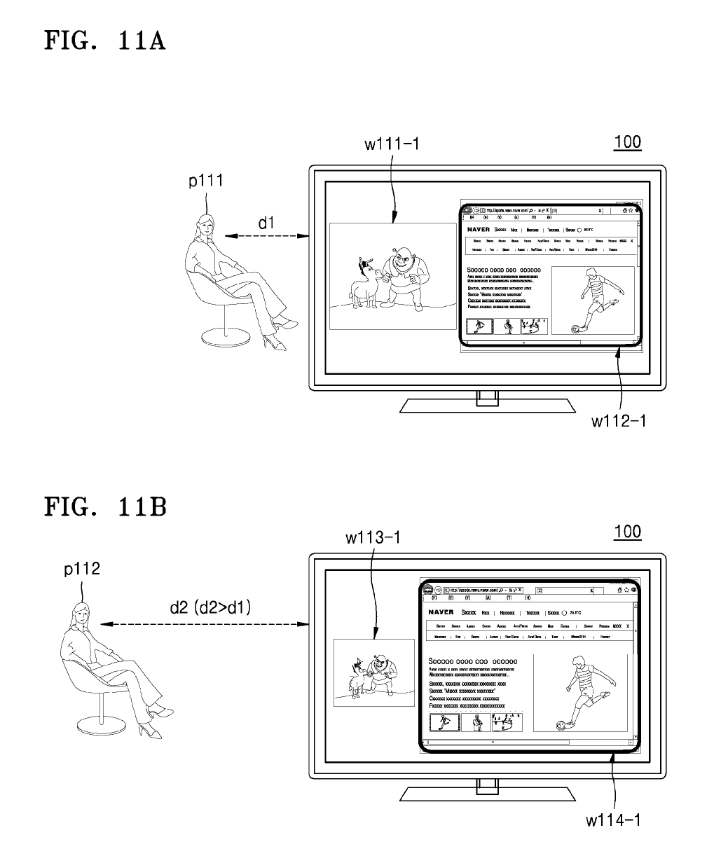

FIGS. 11A and 11B are views for explaining an example of determining a resizing ratio for a target window, according to an exemplary embodiment.

According to an exemplary embodiment, the device 100 may determine a resizing ratio for a window according to a viewing distance of a user.

Referring to FIGS. 11A and 11B, when the user is distant from the device 100 (for example, a TV), the size of the window may be enlarged more than when the user is close to the device 100, in order to secure the ability of the user to read the content.

When a distance d2 by which the device 100 is separated from a user p112 in FIG. 11B is greater than a distance d1 by which the device 100 is separated from a user pill in FIG. 11A, an enlargement ratio of the size of a target window w114-1 of FIG. 11B may be greater than an enlargement ratio of the size of a target window w112-1 of FIG. 11A.

The device 100 may include a sensor module 140 for acquiring a distance by which a user is away from the device 100. The sensor module 140 may include a camera, an infrared sensor, or the like.

For example, the device 100 may determine a distance by which a user is separated from the device 100, via an image captured by a camera. The device 100 may recognize a user who is within a threshold distance from the device 100, via an infrared sensor. The device 100 may then determine a distance by which the user is separated from the device 100 based on the image captured by the camera and/or the information from the infrared sensor.

According to another exemplary embodiment, the device 100 may determine a resizing ratio for a target window, based on preset user information.

The user information may be, for example, age information of the user, eyesight information thereof, or size information of a window preferred by the user.

For example, when the user is older or has bad eyesight, the device 100 may determine a high enlargement ratio for the target window than in a case in which the user is younger or has good eyesight.

The device 100 may determine an enlargement ratio for the target window according to size information of a preferred window that is preset by the user.

FIGS. 12A to 12C are views for explaining an example of rearranging windows other than a target image according to resizing of the target window, according to an exemplary embodiment.

According to an exemplary embodiment, as the device 100 resizes a target window, the device 100 may resize windows other than the target window from among a plurality of windows displayed on the display 121.

Referring to FIG. 12A, as a target window w122 is enlarged to form a window w122-1 in FIG. 12B, remaining windows w121, w123, and w124 of FIG. 12A may be reduced in size and rearranged as windows w121-1, w123-1, and w124-1 in FIG. 12B.

As the target window w122 of FIG. 12A is enlarged to form a window w122-2 of FIG. 12C, the remaining windows w121, w123, and w124 may be reduced in size and rearranged as windows w121-2, w123-2, and w124-2 of FIG. 12C.

The aforementioned exemplary embodiments should be considered in a descriptive sense only and not for purposes of limitation, and are not limited to an order of the operations in the flowcharts of FIG. 2, 6, 9A or 9B. According to other exemplary embodiments, some operations may be skipped or added, and an order of some operations may be changed.

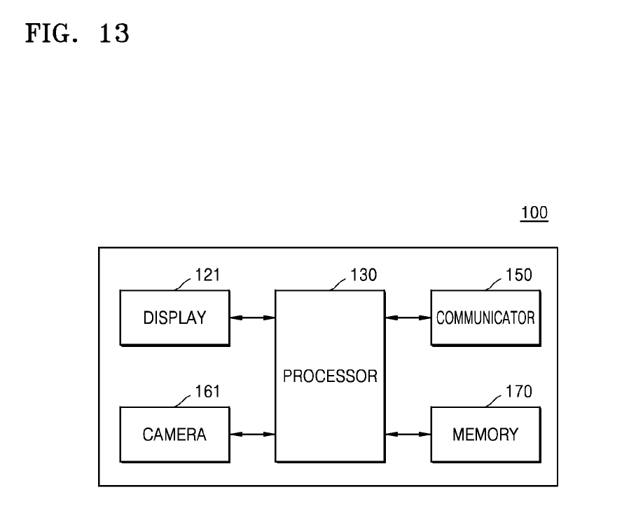

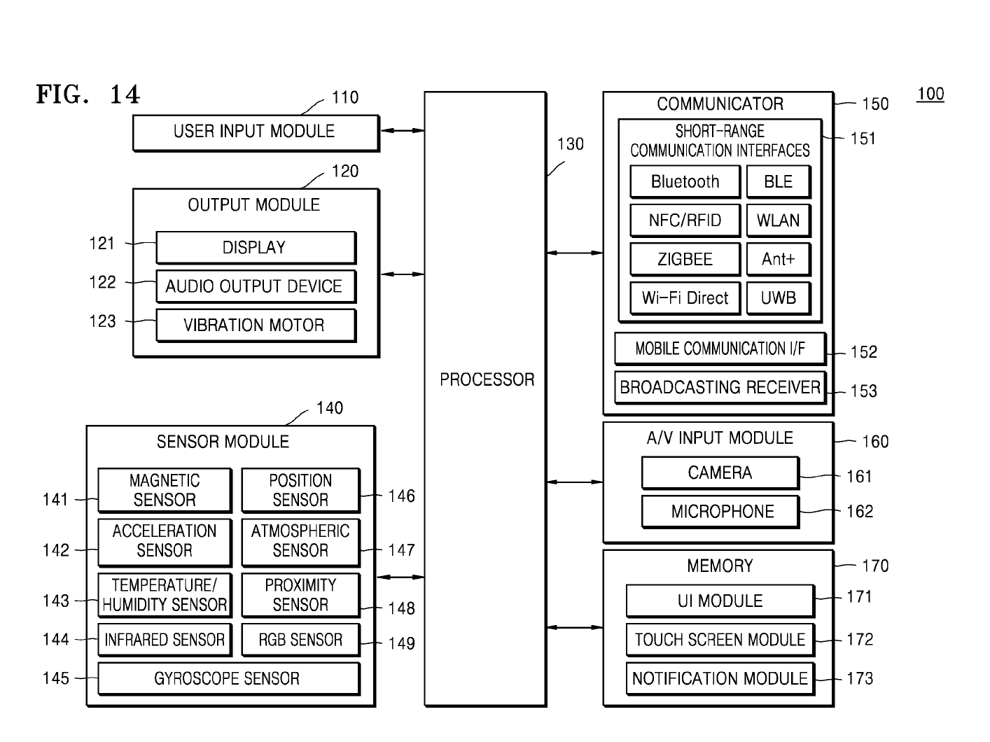

FIGS. 13 and 14 are block diagrams of the device 100 according to an exemplary embodiment.

Referring to FIG. 13, the device 100 may include the display 121, a camera 161, a communicator 150, a memory 170, and the processor 130. However, all of the illustrated components are not essential. The device 100 may be implemented by more or fewer components than those illustrated in FIG. 13.

For example, as illustrated in FIG. 14, the device 100 may further include the sensor module 140, a user input module 110, an output module 120, and an audio/video (A/V) input module 160, in addition to the camera 161, the communicator 150, the display 121, and the processor 130.

The aforementioned components will now be described in detail.

The user input module 110 denotes a module via which a user inputs data for controlling the device 100. For example, the user input module 110 may be, but is not limited to, a key pad, a dome switch, a touch pad (e.g., a capacitive overlay type, a resistive overlay type, an infrared beam type, an integral strain gauge type, a surface acoustic wave type, a piezo electric type, or the like), a jog wheel, or a jog switch.

The user input module 110 may include an external device that may transmit a control signal via wired/wireless communication through the communicator 150. For example, the user input module 110 may be a mouse, a keyboard, or a remote controller.

The user input module 110 may receive a user input by being controlled by the processor 130. For example, the user input module 110 may receive a user input that selects one of a plurality of windows displayed on the display 121.

The output module 120 outputs an audio signal, a video signal, or a vibration signal under the control of the processor 130, and may include the display 121, an audio output device 122, and/or a vibration motor 123.

The display 121 displays information that is processed in the device 100, under the control of the processor 130.

For example, the display 121 may include a plurality of windows that constitute a multi-window. The display 121 may change the number of the plurality of windows and display the windows.

The display 121 may enlarge or reduce the size of the windows and display enlarged or reduced windows, by being controlled by the processor 130. The display 121 may rearrange and display the plurality of windows, by being controlled by the processor 130.

When the display 121 forms a layer structure together with a touch pad to construct a touch screen, the display 121 may be used as an input device as well as an output device. The display 121 may include at least one of a liquid crystal display (LCD), a thin film transistor-liquid crystal display (TFT-LCD), an organic light-emitting diode (OLED), a flexible display, a 3D display, and an electrophoretic display. According to exemplary embodiments of the device 100, the device 100 may include at least two displays 121. The at least two displays 121 may be disposed to face each other by using a hinge.

The audio output device 122 may output audio data that is received from the communicator 150 or stored in the memory 170. The audio output device 122 may also output an audio signal (for example, a call signal receiving sound, a message receiving sound, or a notification sound) related with a function of the device 100. The audio output device 122 may include, for example, a speaker or a buzzer.

The vibration motor 123 may output a vibration signal. For example, the vibration motor 123 may output a vibration signal corresponding to an output of audio data or video data (for example, a call signal receiving sound or a message receiving sound). The vibration motor 123 may also output a vibration signal when a touch screen is touched.

The processor 130 typically controls all operations of the device 100. For example, the processor 130 may control the user input module 110, the output module 120, the sensor module 140, the communicator 150, the A/V input module 160, and the like by executing programs stored in the memory 170. The processor 130 may include one or more microprocessors.

In detail, the processor 130 may determine one of a plurality of windows displayed on the display 121, as a target window.

The processor 130 may determine at least a partial area for acquiring the size of an object displayed on the target window on the display 121.

The processor 130 may acquire the size of an object included in the determined area on the display 121.

The processor 130 may resize and display the target window on the display 121, based on the size of the object. When the size of the object is less than or equal to a reference size, the processor 130 may enlarge the size of the target window and display a size-enlarged target window. When the size of the object is greater than the reference size, the processor 130 may reduce the size of the target window and display a size-reduced target window.

The processor 130 may determine the target window, based on a user input that is input via the user input module 110 to select one from among the plurality of windows.

The processor 130 may change the position of the area for acquiring the size of the object, or resize the area, based on the user input made via the user input module 110.

The processor 130 may acquire the size of text included in the determined area on the display 121, or recognize text from an image included in the determined area and then acquire the size of the recognized text.

The processor 130 may automatically determine whether to resize the target window displayed on the display 121, according to the size of an object acquired at a time interval. The time interval may be predetermined, and may be, for example, 1, 5, 10 seconds, etc.

The processor 130 may receive, via the user input module 110, a user input regarding whether to resize the target window displayed on the display 121, according to the size of the object acquired at the time interval.

The sensor module 140 may sense the status of the device 100 or the status of the surrounding of the device 100 and may transmit information corresponding to the sensed status to the processor 130. The sensor module 140 may include, but is not limited thereto, at least one selected from a magnetic sensor 141, an acceleration sensor 142, a temperature/humidity sensor 143, an infrared sensor 144, a gyroscope sensor 145, a position sensor (e.g., a GPS) 146, a pressure sensor 147, a proximity sensor 148, and an RGB sensor 149 (i.e., an illumination sensor). Functions of most of the sensors would be instinctively understood by one of ordinary skill in the art in view of their names and thus detailed descriptions thereof will be omitted herein.

The sensor module 140 may include a sensor for sensing a touch input made via an input tool, and a sensor for sensing a touch input made by a user. In this case, the sensor for sensing the touch input by the user may be included in the touch screen or the touch pad. The sensor for sensing the touch input via the input tool may be formed below or in the touch screen or the touch pad.

The sensor module 140 may acquire a distance by which a user is away from the device 100. For example, the sensor module 140 may include an infrared sensor 144. In other words, the processor 130 may recognize a user who is within a predetermined distance from the device 100, via the infrared sensor 144.

The communicator 150 may include at least one component that enables the device 100 to perform data communication with an external device or a server (not shown). For example, the communicator 150 may include a short-range wireless communication interface 151, a mobile communication interface (I/F) 152, and/or a broadcasting receiver 153.

The short-range wireless communication interface 151 may include, but is not limited to, a Bluetooth communicator, a Bluetooth Low Energy (BLE) communicator, a near field communication (NFC) interface, a wireless local area network (WLAN) (e.g., Wi-Fi) communicator, a ZigBee communicator, an infrared Data Association (IrDA) communicator, a Wi-Fi direct (WFD) communicator, an ultra wideband (UWB) communicator, an Ant+communicator, and the like.

The mobile communication interface 152 may exchange a wireless signal with at least one selected from a base station, an external terminal, and a server on a mobile communication network. Examples of the wireless signal may include a voice call signal, a video call signal, and various types of data generated during a short message service (SMS)/multimedia messaging service (MMS).

The broadcasting receiver 153 receives a broadcasting signal and/or broadcasting-related information from an external source via a broadcasting channel. The broadcasting channel may be a satellite channel, a ground wave channel, or the like. According to exemplary embodiments, the device 100 may not include the broadcasting reception unit 153.

The A/V input module 160 inputs an audio signal or a video signal, and may include, for example, the camera 161 and a microphone 162. The camera 161 may acquire an image frame, such as a still image or a moving picture, via an image sensor in a video call mode or a photography mode. An image captured via the image sensor may be processed by the processor 130 or a separate image processor (not shown).

The image frame obtained by the camera 161 may be stored in the memory 170 or transmitted to the outside via the communicator 150. In some exemplary embodiments, at least two cameras 161 may be included in the structure of a device.

The processor 130 may recognize a user from the image captured by the camera 161 and extract a distance by which a user is separated from the device 100.

The microphone 162 receives an external audio signal and converts the external audio signal into electrical audio data. For example, the microphone 162 may receive an audio signal from an external device or a speaking person. The microphone 162 may use various noise removal algorithms in order to remove noise that is generated while receiving the external audio signal.

The memory 170 may store a program that is used by the processor 130 to perform processing and control, or may store input/output data.

The memory 170 may include at least one type of storage medium. The storage medium may be, for example, a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and/or an optical disk. The device 100 may operate a web storage or a cloud server on the internet which performs a storage function of the memory 170.

The programs stored in the memory 170 may be classified into a plurality of modules according to their functions, for example, a UI module 171, a touch screen module 172, and a notification module 173.

The UI module 171 may provide a UI, GUI, or the like that is specialized for each application and interoperates with the device 100. The touch screen module 172 may detect a touch gesture on a touch screen of a user and transmit information regarding the touch gesture to the processor 130. The touch screen module 172 according to an exemplary embodiment may recognize and analyze a touch code. The touch screen module 172 may be configured by separate hardware including a controller.

In order to detect the actual touch or the proximate touch on the touch pad, the touch screen may internally or externally have various sensors. An example of a sensor used to detect the real touch or the proximity touch on the touch screen is a tactile sensor. The tactile sensor denotes a sensor that detects a touch by a specific object to a degree to which a human feels or more. The tactile sensor may detect various types of information, such as the roughness of a touched surface, the hardness of the touching object, the temperature of a touched point, and the like.

Another example of a sensor used to detect the real touch or the proximity touch on the touch screen is a proximity sensor. The proximity sensor is a sensor that detects the existence of an object that approaches a predetermined detection surface or that exists nearby, by using an electromagnetic force or infrared rays, without using any mechanical contact. Examples of the proximity sensor include a transmission-type photoelectric sensor, a direct reflection-type photoelectric sensor, a mirror reflection-type photoelectric sensor, a high frequency oscillation-type proximity sensor, a capacity-type proximity sensor, a magnetic proximity sensor, an infrared-type proximity sensor, or the like. Examples of the touch gesture of the user may include tap, touch and hold, double tap, drag, panning, flick, drag and drop, swipe, and the like.

The notification module 173 may generate a signal for notifying that an event has been generated in the device 100. Examples of the event generated in the device 100 may include call signal receiving, message receiving, a key signal input, schedule notification, and the like. The notification module 173 may output a notification signal in the form of a video signal via the display 121, in the form of an audio signal via the audio output module 122, or in the form of a vibration signal via the vibration motor 123.

The present inventive concept may also be embodied as a storage medium including instruction codes executable by a computer such as a program module executed by the computer. A computer readable medium may be any usable medium which may be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes any information transmission medium.

The terminology “˜module” used herein may be a hardware component such as a processor or a circuit, and/or a software component that is executed by a hardware component such as a processor.

Although the exemplary embodiments have been disclosed for illustrative purposes, one of ordinary skill in the art will appreciate that diverse variations and modifications are possible, without departing from the spirit and scope of the inventive concept. Thus, the above exemplary embodiments should be understood not to be restrictive but to be illustrative, in all aspects. For example, respective elements described in an integrated form may be dividedly used, and the divided elements may be used in a state of being combined.

The exemplary embodiments should be considered in descriptive sense only and not for purposes of limitation. Descriptions of features or aspects within each exemplary embodiment should typically be considered as available for other similar features or aspects in other exemplary embodiments.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed is:

1. A device comprising:
a display configured to display a plurality of windows; and
a processor configured to determine one of the plurality of windows as a target window, determine at least a partial area for acquiring a size of an object displayed in the target window, acquire a size of an object included in the determined at least partial area, resize the target window based on the size of the object, and display the resized target window.

2. The device of claim 1, wherein, when the size of the object is less than or equal to a reference size, the processor enlarges the size of the target window and displays the size-enlarged target window, and, when the size of the object is greater than the reference size, the processor reduces the size of the target window and displays the size-reduced target window.

3. The device of claim 1, wherein the processor determines the target window, based on a user input of selecting one window from among the plurality of windows.

4. The device of claim 1, wherein the processor determines the at least a partial area, based on an area including text in the target window.

5. The device of claim 1, wherein the processor changes a position or a size of the at least a partial area, based on a user input.

6. The device of claim 5, wherein, when the position or size of the at least a partial area has been changed, the processor reacquires the size of the object.

7. The device of claim 1, wherein the processor determines a center area corresponding to a ratio of the target window, as the at least a partial area for acquiring the size of the object.

8. The device of claim 1, wherein the processor controls an indicator indicating the at least a partial area for acquiring the size of the object, to be displayed in the target window.

9. The device of claim 1, wherein the processor acquires the size of text included in the determined at least a partial area, or recognizes text from an image included in the determined at least a partial area, and then acquires a size of the recognized text.

10. The device of claim 1, wherein the processor acquires the size of the object periodically based on a time interval.

11. The device of claim 10, wherein the processor automatically determines whether to resize the target window at each acquisition of the size.

12. The device of claim 10, wherein the processor receives a user input regarding whether to resize the target window the acquisition of the size.

13. The device of claim 1, wherein
the processor determines a ratio for resizing the target window, based on preset user information, and
the preset user information comprises at least one of size information of a preferred window, age information, and eyesight information.

14. The device of claim 1, further comprising a sensor module configured to acquire a distance by which a user is separated from the device,
wherein the processor determines a ratio for resizing the target window, based on the distance.

15. The device of claim 1, wherein, as the processor resizes the target window, the processor resizes windows other than the target window from among the plurality of windows displayed on the display.

16. A method comprising:
determining, as a target window, one of a plurality of windows displayed on a display;
determining at least a partial area for acquiring a size of an object displayed in the target window;
acquiring a size of an object included in the determined at least a partial area; and
resizing the target window based on the size of the object and displaying the resized target window.

17. The method of claim 16, wherein the resizing of the target window based on the size of the object and displaying of the resized target window comprises, when the size of the object is less than or equal to a reference size, enlarging the size of the target window and displaying the size-enlarged target window, and, when the size of the object is greater than the reference size, reducing the size of the target window and displaying the size-reduced target window.

18. The method of claim 16, wherein the target window is determined by selecting one from among the plurality of windows based on a user input.

19. The method of claim 16, wherein the at least a partial area is determined based on an area including text in the target window.

20. The method of claim 16, wherein the determining of the at least partial area comprises changing a position or a size of the at least a partial area based on a user input.

21. The method of claim 20, further comprising, when the position or size of the at least a partial area has been changed, reacquiring the size of the object.

22. The method of claim 16, wherein the determining of the at least a partial area comprises determining a center area corresponding to a ratio of the target window, as the at least a partial area.

23. The method of claim 16, further comprising displaying an indicator for indicating the at least a partial area in the target window.

24. The method of claim 16, wherein the acquiring of the size of the object comprises acquiring the size of text included in the determined at least a partial area, or recognizing text from an image included in the determined at least a partial area, and then acquiring a size of the recognized text.

25. The method of claim 16, wherein the size of the object is acquired periodically based on a time interval.

26. The method of claim 25, further comprising automatically determining whether to resize the target window at each acquisition of the size of the object.

27. The method of claim 25, further comprising receiving a user input regarding whether to resize the target window at the acquisition of the size of the object.

28. The method of claim 16, wherein
the resizing of the target window based on the size of the object and displaying of the resized target window comprises determining a ratio for resizing the target window based on preset user information, and
the preset user information comprises at least one of age information, eyesight information, and size information of a preferred window.

29. The method of claim 16, wherein the resizing of the target window based on the size of the object and displaying of the resized target window comprises acquiring a distance by which a user is separated from the device, and determining a ratio for resizing the target window, based on the distance.

30. The method of claim 16, further comprising, as the target window is resized, resizing windows other than the target window from among the plurality of windows displayed on the display.

31. A device comprising:
a display configured to display a plurality of windows; and
a processor configured to automatically resize a window of the plurality of windows in response to a change in the size of an object included in the window.

32. The device of claim 31, wherein the object is text, and the change is a change in the size of the text.

33. The device of claim 31, wherein the object is an image, and the change is a change in the size of the image.

34. The device of claim 31, wherein the processor determines a size of the object, and when the size of the object is less than or equal to a reference size, the processor enlarges the size of the window that includes the object and displays the size-enlarged window, and, when the size of the object is greater than the reference size, the processor reduces the size of the window that includes the object and displays the size-reduced target window

35. The device of claim 31, wherein as the processor resizes the window, the processor also resizes one or more of remaining windows among the plurality of windows.

36. The device of claim 35, wherein as the processor increases the size of the window, the processor decreases the size of one or more of remaining windows among the plurality of windows.

37. The device of claim 35, wherein as the processor decreases the size of the window, the processor increases the size of one or more of remaining windows among the plurality of windows.
